(19) United States
(12) Patent Application Publication
(10) Pub. No.: US 2004/0060757 A1
(43) Pub. Date: Apr. 1, 2004

(54) Apparatus and methods for illuminating space and illumination sources for automotive collision avoidance system

(76) Inventor: James Plante, Del Mar, CA (US)

Correspondence Address: Joseph Page, P.O. Box 757, La Jolla, CA, 92038, US

(21) Appl. No.: 10/255,318

(22) Filed: Sep. 26, 2002

(51) Int. Cl. B62D 1/24

(52) U.S. Cl. 180/169

(57) ABSTRACT

Automotive collision avoidance systems operable in inclement weather and harsh environments such as motorways are presented. Anticollision systems of these inventions are configured with specialized source and detection subsystems to provide operation with energy beams having relatively long wavelengths. Optical beams characterized as middle infrared or ‘mid-IR’ are used for their ability to stand up against factors which tend to strongly attenuate optical beams of more common spectra such as near IR. In some versions, specialized quantum cascade lasers are arranged as optical beam sources. Quantum cascade lasers efficiently generate high energy beams of long wavelength; for example between 3 and 30 micrometers. These beams of long wavelength tend to better penetrate free-space contaminated with small particulate matter. In addition, these systems include specialized detection subsystems which operate with high detectivity in the mid-IR spectral region. Together, these source and detector combinations allow automotive collision avoidance systems which remain operable where other systems will surely fail.

### BACKGROUND OF THE INVENTION

1. Field

The field of these inventions described here following may be characterized as automotive collision avoidance systems and in particular those automotive collision avoidance systems resistant to interruptions due to fog and other elements of inclement weather as well as elements of road environments.

2. Prior Art

Automotive collision avoidance systems are well known. More importantly, their benefits are now well proven and soon all cars will employ such systems to further improve the safety of general purpose automobiles.

In most electronic collision avoidance schemes, an electromagnetic beam of energy is transmitted from a car into its surroundings. The beam interacts with objects of the environment including other cars nearby and a portion of the beam reflects back to the car from which it came. There, the beam is detected and measured for properties which might indicate important information regarding the surroundings. Because modern computer processors are extremely fast and inexpensive, a collision avoidance system is possible where the computer analyzes the return beam in real-time and provides a response signal to cooperating automotive facilities such as accelerator and brakes and possibly alarms.

Diode Laser, Near IR Approach

In a first approach, use of inexpensive infrared IR diode lasers are common. These electronic devices are cheap, easy to work with, highly reliable and thus are a leading candidate from which systems are built. They offer very good beam control and multiplexing opportunity. It is not difficult to separate signals from independent systems which might be operating nearby. Coupling to free space is readily accomplished with minimal hardware arrangements. Sufficient energy is easily achievable without special apparatus or supporting systems. On the face of it, IR laser diodes offer great solutions.

Inventions taught by H. R. Everett, Jr., are based on near-infrared ranging systems. These are particularly directed to laser radars having high angular resolutions. They employ arrays of light emitters that can be sequentially incremented by a microprocessor. While these systems are expected to provide significant advantages, these advantages are necessarily accompanied by the problem that near IR light does not propagate well in fog and other unfriendly environments. Thus, while these inventions are useful, they are so long as the environment remains favorable with respect to the vulnerabilities of the systems.

Similarly, U.S. Pat. No. 5,249,157 presents a collision avoidance system based upon diode lasers. It presumes that the cars to be detected are previously prepared with retroreflectors. In this way, these systems assure very strong return signals which might improve overall performance in bad weather conditions. The system further includes a very high resolution and high scan rate. 300,000 pixels/sec are scanned in the field-of-regard. Considerable other advantages are presented.

Finally, a collision avoidance system is taught by Shaw et al in U.S. Pat. No. 5,529,138 entitled “Vehicle Collision Avoidance System”. Various sensors are distributed about vehicle subsystems to measure conditions which suggest an impending collision. In some cases, an automatic breaking subsystem may apply a stopping action to prevent a collision. These systems, while having their benefits to be certain, nevertheless suffer from the same problem as the others. Laser diodes used by Shaw et al are limited because the wavelengths available at sufficient power levels are to short to penetrate fog and rain and other particulate matter. Further, atmospheric turbulence tends to degrade propagation of optical beams. The energy is quickly absorbed, scattered or otherwise attenuated whereby these optical systems are rendered inoperable.

Practitioners of these near IR laser diode approaches will be first to testify to limiting disadvantages which might not be apparent on a first look. Collision avoidance systems based on IR laser diodes suffer from complete failure in even light fog conditions. Further, light rain and hail tend to cause serious failure as well and may leave these systems inoperable. In addition, particulate matter associated with motorways such as dust is well formed to interrupt energy beams from IR laser diodes. This is due to the fact that road particulate is generally of a size which is especially uncooperative with the wavelength of these energy beams. Diodes produce light in the so-called ‘near IR’ spectrum, typically of 1.5 micrometer and less in wavelength. Since particles common on roadways tend to include particles of similar size, scattering is greatly increased for beams of this wavelength. Thus, although laser diodes of near IR wavelengths are readily available and well engineered, they are not always useful for anticollision systems because they do not cooperate with some of the tasks at hand; i.e., they do not perform well in the presences of fog, other elements of inclement weather, and road dust and pollution.

Microwave Approach

Collision avoidance systems introduced recently may be based upon a microwave beam which emanates from a moving car.

In an example microwave system, a microwave oscillator generates microwave energy in the form of a beam and sends that microwave beam in a forward looking direction. The beam propagates at the speed of light towards any objects which may be ahead of the car in the general direction of travel. Those objects tend to affect changes to the beam which would not occur in the case where no objects are present. Particularly, the beam may be reflected from the objects and return to the car which emitted the beam. Upon detection of a dangerous condition, for example, when another car has a closing rate which approaches the maximum braking limit of the car, a collision may be determined immanent. Upon detection of such condition, the car may be subject to a modest braking action under control of the computer rather than the vehicle operator. In this way, a car could stop itself without input from a driver who otherwise did not determine the existence of the dangerous condition.

Microwave systems are quite remarkable for several reasons. The energy necessary for collision avoidance systems is easily achievable with inexpensive microwave components. In addition, microwave device technologies including detectors and amplifiers are very mature and well developed. Consequently, microwave systems can be engineered to be compatible with use in common automobiles. Microwave systems are considered environmentally ‘clean’ and tend not to disturb unrelated electronics. Accordingly, microwave based collision avoidance systems remain at the forefront of this field.

Although benefits of microwave systems are in fact numerous, there are serious disadvantages. Where hundreds of cars are together on a crowded motorway, microwave energy tends to suffer multiple reflections which interfere with nearby systems. Where a sufficient number of cars are present, the ‘noise’ level would render all systems ineffective or at least result in reduced efficacy. Still further, and most importantly, microwave systems suffer a tremendous disadvantage with regard to attenuation due to particulates in the environment. Although it is implied that these are ‘free-space’ systems, they are in fact arranged to operate in environments which are not exactly ‘free-space’. Indeed, the ‘free-space’ surrounding motorways tends to be quite a bit less than ‘free’. It includes, pollutants such as large water drops from road spray and other particulate. Hail and snow, which are sometimes present during the normal operation of motor vehicles, tend to absorb and scatter a microwave beam such that it cannot be effectively used in anti-collision systems. Thus, microwave based collision avoidance systems are defective in the sense that where they are needed most, they fail to maintain operability. Even more troublesome, are problems associated with antenna and microwave component size. Large antennas and waveguides leave tend to leave microwave systems incompatible with descrete deployment in automobile platforms.

The disclosure entitled “Vehicular Anticollision Radar System for Driving in the Fog” presented as U.S. Pat. No. 5,045,856 presents and interesting example of an anti-collision system based upon microwave or radio beams. This teaching is of particular interest because it recognizes the difficulty these systems with respect to their operation in fog. Further, he presents a strategy to support improved operation in fog and presumably other elements of harsh road environments.

GPS Approach

Other systems arranged to prevent collisions include those based on simultaneous position measurements of a plurality of objects. These inventions do not directly measure the presence of other vehicles nearby but rather they implicitly detect them by way of independent position measurements, for example via a GPS system. These systems are excellent solutions for the interference found in systems having an active radar/lidar. Fog and rain does not interfere appreciably with the signals of a GPS system. Position and direction of travel information for two or more vehicles near one another can be monitored by a central server. Decisions can be made at a signal processor and instructions may be transmitted to moving vehicles to prevent instances of collision.

Illustrative of these systems is one presented by prolific inventor the late Jerome Lemelson described in U.S. Pat. No. 6,275,773. This disclosure entitled “GPS Vehicle Collision Avoidance Warning and Control System and Method” is directed to solutions whereby a neural network processes a great plurality of measured information from one or more vehicles simultaneously to provide feedback to each of them such that collisions may be avoided.

The problem with these systems again lies in the fact that not all vehicles are equipped with the devices. A vehicle unknown to the system presents a serious problem as it lies in a virtual blind spot. A driver would not be aware of the fact that the vehicle is not seen by the system and may develop a false sense of security where added defense is actually called for. Until all cars are equipped with these GPS systems, the entire scheme suffers the shortcoming that the system only prevents collisions with objects known to the system.

It is therefore desirable to create anti-collision systems which remain operable in fog, heavy rain, hail, snow, and in addition in environments including road dust and associated pollutants while also providing the ability to detect objects inactive with respect to the system.

While systems and inventions of the art are designed to achieve particular goals and objectives, some of those being no less than remarkable, these inventions have limitations which prevent their use in a manner consistent with applications taught herein. These inventions of the art are not used and cannot be used to realize the advantages and objectives of the present invention.

### SUMMARY OF THE INVENTION

Comes now, James Plante with inventions of collision avoidance systems for automobiles employing subsystems of mid-IR optical radiation including both apparatus and methods. It is a primary function of these inventions to provide collision avoidance systems which remain operable in the most adverse of conditions including those conditions where heavy fog, rain, and other elements of inclement weather may be present. Further, these systems remain operable in environments contaminated by heavy particulate matter such as dust associated with common motorways. It is a contrast to methods and devices in the arts that those systems do not provide active anti-collision systems durable against conditions and environments occasioned in normal use of automobiles. A fundamental difference between collision avoidance systems of the instant inventions and those of the art can be particularly found when considering the highly specialized energy sources and unique detection subsystems.

These inventions stand in contrast to methods and devices known heretofore; none of which sufficiently serve collision avoidance applications with high reliability. These inventions include collision avoidance systems having high powered mid-IR optical sources and special cooperating detection apparatus and technique tuned for high detectivity in the spectral region of concern. In contrast, the art includes arrangements having microwave and common near IR energy sources and conventional detection means.

### OBJECTS OF THE INVENTION

It is a primary object of these inventions to provide automotive collision avoidance systems.

It is an object of these inventions to provide collision avoidance systems durable against environmental components.

It is an object of these inventions to provide collision avoidance systems which are not severely affected by rain, fog, hail and other elements of weather.

It is an object of these inventions to provide collision avoidance systems which are not severely affected by motorway particulate matter including pollution, dust, rubber, among others.

It is an object of these inventions to provide collision avoidance systems having optical sources and detection means which cooperate with energy beams of Mid-IR wavelengths in adverse environments.

A better understanding can be had with reference to detailed description of preferred embodiments and with reference to the appended drawing. Embodiments presented are particular ways to realize these inventions and are not inclusive of all ways possible. Therefore, there may exist embodiments that do not deviate from the spirit and scope of this disclosure as set forth by the claims, but do not appear here as specific examples. It will be appreciated that a great plurality of alternative versions are possible.

### BRIEF DESCRIPTION OF THE DRAWING FIGURE

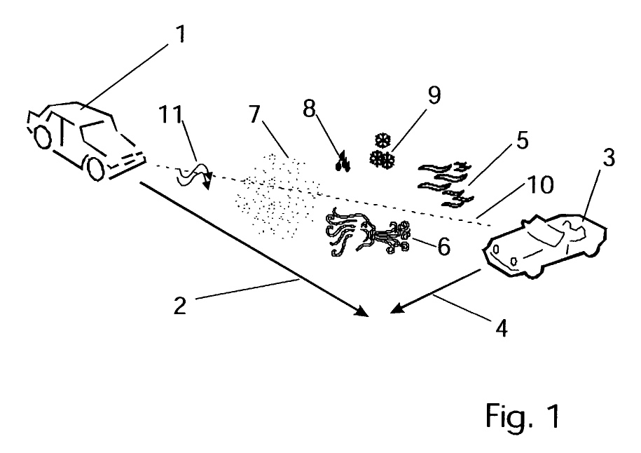

These and other features, aspects, and advantages of the present invention will become better understood with regard to the following description, appended claims and drawing where FIG. 1 illustrates a scenario whereby two cars are on a collision course in inclement weather.

### GLOSSARY OF SPECIAL TERMS

Throughout this disclosure, reference is made to some terms which may or may not be exactly defined in popular dictionaries as they are defined here. To provide a more precise disclosure, the following terms are presented with a view to clarity so that the true breadth and scope may be more readily appreciated. Although every attempt is made to be precise and thorough, it is a necessary condition that not all possible meanings associated with each term can be completely set forth. Accordingly, each term is intended to also include its common meaning which may be derived from general usage within the pertinent arts or by dictionary meaning. Where the presented definition is in conflict with a dictionary or arts definition, one must use the context of use and liberal discretion to arrive at an intended meaning. One will be well advised to error on the side of attaching broader meanings to terms used in order to fully appreciate the depth of the teaching and to understand all the intended variations.

‘Mid-IR’ or Middle Infrared

Mid-IR radiation includes those optical wavelengths from about 3 microns to about 20 microns. For purposes of this invention, the Mid-IR portion of the spectrum is meant to include optical wavelengths between about 3 and 20 microns. With recognition that some writings may suggest different definitions for a Mid-IR region of the spectrum, the definition provided is useful for guidance in consideration of the concepts discussed. Where a particular wavelength is called out, it is intended that a linewidth exists where the wavelengths on either side of a center wavelength are also included. Some lasers presented herein have very unusually broad linewidths. For example: ‘9.5 microns’ might fairly represent 9.5 microns ±0.5 microns.

Optical Beam Source

An optical beam source is a source of light suitable for producing a beam via lenses or mirrors. An optical beam source may include both laser and non-laser devices. Although ‘lasers’ are used in most examples, it should be understood and recognized that a very special class of light emitting device which is not technically a laser may also work in some versions. Therefore strictly speaking ‘optical beam source’ should include both laser and non laser type light source devices.

Detectors

Detectors are transducers responsive to photon input operable for generating an electronic signal either current or voltage. Thus, detectors of these inventions can be either photoconductive or photovoltaic. They may be either diode type devices or non-diode type structures such as quantum well type photodetectors.

Free Space

Although ‘free space’ may seem to imply space entirely free of matter, recent and common use suggests otherwise. Indeed, ‘free space’ as used here is in agreement with definitions where ‘space’ contains at least atmospheric air and perhaps other matter such as fog, haze, hail, snow, rain, dirt, dust, pollution, gases, currents, density gradients, among others. In this definition, ‘free space’ is meant to be the absence of optical confinement by waveguides.

### PREFERRED EMBODIMENTS OF THESE INVENTIONS

In accordance with each of preferred embodiments of these inventions, there is provided collision avoidance systems. It will be appreciated that each of the embodiments described may include both apparatus and methods and that an apparatus or method of one preferred embodiment may be different than an apparatus or method of another embodiment.

A tremendous cost with regard to life and limb as well as monetary cost may be attributed to automobile accidents every day. Some accidents which contribute to this great loss suffered by us all are preventable. In particular, those accidents which could be predicted by advanced sensors and fast computers.

When cars are traveling on roadways at speeds sometimes greater than 90 miles per hour, there is very little time between when an operator recognizes conditions which suggest a likely accident and the moment of impact. Frequently, this condition is realized at a moment when there is insufficient time remaining for a human operator to apply an appropriate response. Accordingly, the earlier an operator can become aware of an impending crash condition, the more likely one might be able to avoid the collision. Thus some versions of these inventions are arranged to provide a potential collision alarm to the operator of a moving vehicle.

In other advanced versions, these systems may be arranged to detect conditions indicative of an impending smash and provide stimulus to a response subsystem which may apply evasive action. An emergency braking system might be applied despite or in conjunction with activity taken by an operator. Similarly, an automatic steering apparatus may be activated to alter the path of the automobile in jeopardy so as to traverse the detected adverse condition Thus, these inventions include means to provide the trigger to initiate automatic evasive action taken under computer control.

Many different strategies for building a collision avoidance system will require a fast and reliable probe and detection system. These components are taught here without regard for the final configuration of any particular anti-collision system.

Inclement Weather

As is clear from the prior art, the choice of wavelength for a probe beam is selectable over a very broad spectrum. At the long wavelength end, radio or microwave beams have been demonstrated as good candidates in some anticollision systems. However, heavy rain tends to disrupt microwave beams and limit the effectiveness of anti-collision systems during weather conditions with include heavy rain. This is exacerbated because even in light rain, where there is heavy traffic, water on the roadway tends to be reintroduced into the air by the action of automobile tires on the asphalt. Accordingly, in conditions which tend to increase the need for anticollision systems, their efficacy is actually reduced if the system relies upon a longwave beam for a sensor probe.

In a similar and related problem, anticollision systems having electromagnetic probes of higher energy photons, i.e. shorter wavelength optical energy of approximately 1.6 micron or less or ‘near IR’ , can be severely degraded by fog and mist commonly found in normal operating conditions associated with use of automobiles. An optical beam from a laser diode typically emits beams of energy having a wavelength of 1.55 microns or sometimes less. While near IR beams are convenient as they are compatible with inexpensive optical components, easy to detect, readily available, among other advantages, systems based upon these beams suffer complete failure in the presence of fog. Where one wishes an anti-collision system to remain operable in foggy environments, the system should not be based on near IR wavelengths.

In the middle, lies spectrum of special interest. The Mid-IR spectral region lies between near IR and radio. Perhaps best defined as between about 3 and 20 microns, light beams of these wavelengths have special properties indeed. Namely, there exists an ‘atmospheric window’ of finite width near about both 5 and 10 microns. That is to say, components of the atmosphere tend not to disturb the propagation of an energy beam comprised of electromagnetic energy of wavelength about 5 microns and of about 10 microns.

Further, dust and other particulate tends to disrupt shorter wavelength optical beam to a greater degree. While dust certainly scatters all forms of light, various types of scattering mechanisms are attributed to the properties of the scattering particulate. It is not the case that scattering of this nature is independent of wavelength, but rather, it is wavelength dependent. A scattering mechanism known as ‘MIE scattering’ is an example. MIE scattering is wavelength dependant and more severe for shorter wavelengths. Therefore propagation of long wave light through an environment comprised of MIE scatterers will be better for mid-IR light than for near IR. Similarly, Raleigh scattering is wavelenth dependant and discriminates more severely against near IR than Mid IR which has additional propagation advantage.

For these reasons, it is first suggested here that the optical source best suited for anticollision systems should be a mid-IR optical beam and more particularly, the mid-IR beam from a semiconductor laser of the quantum cascade type is preferred.

Optical Sources

Optical sources suitable for high performance anti-collision systems preferably include lasers or laser-like devices. In particular, a semiconductor laser has clear advantages. ‘Quantum cascade’ lasers are unipolar semiconductor lasers having special and remarkable properties. In particular, these devices produce a high power output beam of mid-IR wavelengths. They are very compact and durable and display very long lifetimes. They are extremely fast and may be directly modulated by current inputs. Because of these properties, among others, they are nicely suited to the task for being integrated with collision avoidance systems.

Quantum cascade lasers are built about the principle that electrons are held in allowed energy states which are controlled by the physical dimensions of the device rather than the chemical composition. Because of this, they are tunable in wavelength to a very high degree. It is therefore possible to arrange these devices for performance in a spectral region of particular interest. Unlike their semiconductor counterpart, the diode laser, quantum cascade lasers display very high performance at 5 and 10 microns. As this corresponds to a pass region or optical window in the atmosphere, anti-collision systems built about a quantum cascade laser have considerable advantage.

Therefore, an optical illumination apparatus including a mid-IR quantum cascade laser having optical gain media electrically connected to a modulator configured to drive it with periodic repetitive electrical pulses provides a foundation upon which an highly reliable anti-collision system of these inventions is built. The lasers are modulated to provide for ranging schemes and other timing events related to anti-collision tasks.

A special kind of quantum cascade laser is particularly suitable for these devices. In many circumstances, a quantum cascade laser only operates with an appreciable duty cycle under cryogenically cooled conditions. As it is extremely difficult to include cryogenically cooled devices as part of automobile equipment, it is preferred that the type of quantum cascade laser used be that of the high temperature version. A quantum cascade laser may be configured with a preferred heat management scheme whereby a InP heat conductive path is include about an otherwise well formed device to more efficiently draw heat away from a device. A metal oxide chemical vapor deposition process to produce a regrowth layer of InP can deposited upon a quantum cascade laser structure to provide a conductive path for improved heat dissipation In best arrangements of this type, a quantum cascade laser may be provided to operate at room temperature and still provide a strong output beam at high duty cycle.

In alternative versions, these quantum cascade devices can be configured with exterior heat management schemes. A laser can be formed and intimately coupled to the cold side of a thermo electric cooling apparatus. Thermo electric cooling is not capable of achieving temperatures as low as cryogenics, however, when appropriately combined with the heat loads produced by a high duty cycle quantum cascade laser, the combination allows one to deploy the device in an automotive application without providing for complex and bulky cryogenic cooling apparatus.

Detectors

One will fully appreciate that the amount of time between scenarios including a perfectly safe condition and one which presents itself as including an impending collision, may be very short. Thus, a system must be very fast in order to detect the impending collision condition and provide enough remaining time for a suitable response. Accordingly, common detectors are inappropriate for these applications because they are too slow. It is necessary to use very fast detectors.

Further as some versions of these systems scan the various spatial portions of a field-of-regard serially in time, a detector should not only be fast, but also very sensitive.

Accordingly, detectors of these inventions must be highly responsive to mid-IR light, they must have exceptionally high bandwidth, and they must be highly sensitive. Therefore, the choice of detector in preferred versions includes mercury-cadmium-zinc-telluride, HgCdZnTe, detector having a D* (pronounced D-star), detectivity of 1×10⁹ or better at high temperature. By ‘high’ temperature, it is meant that any temperature that is above conventional cryogenic temperatures is ‘high’. To further improve the detector response, detectors may be fabricated with an immersion lens integrated therewith the active region of the detector.

Certain arrangements of a special detector known as a quantum well infrared photodetector, or QWIPs, will also serve some versions. Particularly, QWIPs which are highly doped for superior performance at room temperature may be used as these devices are extremely fast and may be tuned to be highly responsive at a particular wavelength including mid-IR wavelengths.

An illustrative example of a possible anti-collision scenario is shown in FIG. 1. A first automobile 1 traveling on route 2 approaches a second automobile 3 traveling on route 4. This is a very common scenario which is likely to occur at intersections where two perpendicular roads cross and share way. In the instance where the speeds and distance are just so, the cars are said to be on a collision coarse whereby without change to either speed or direction of travel, they will surely collide to cause a tremendous mess. To complicate matters, the environment may be contaminated or polluted with components which tend to disrupt operation of typical anti-collision systems.

For example, cars generate severe air currents with associated pressure gradients 5. These gradients tends to cause optical beams to diffract and change propagation direction and cause distortion to spatial mapping. Thus, beams which are not so strongly affected by diffraction effects will tend to permit a system to remain operable in even pronounced gradients. Naturally occurring wind currents 6 also tend to upset optical beam propagation in a similar fashion.

More importantly, fog 7 comprised of microscopic water particles tends to scatter or otherwise attenuate a probe beam of 1.55 micron common with diode type lasers. In fact, fog tends to attenuate optical energy in very broad portions of the spectrum with only a few portions remaining relatively transparent. These so-called ‘atmospheric windows’ are nearly centered at 5 and 10 microns. Light beams comprised of these energies penetrate through fog relatively well. However, diode lasers cannot be easily made to emit light at 10 microns. The principle upon which they operate is a band gap recombination of electrons-hole pairs. It is prohibitively difficult to arrange materials to form a diode junction with a band gap which corresponds to such low energy. Thus, it is first presented here that unipolar type semiconductor lasers combined with other principles of anti-collision systems to form a systems more durable against fog which otherwise tends to defeat systems employing alternative probe beams.

Similarly, rain 8 and snow 9 frequently found during the normal operation of automobiles can cause interference with the probe beams of anti-collision systems. In particular, microwave energy is difficult to transmit in heavy rain. A microwave beam may become fully attenuated leaving an anti-collision system upon which it is based ineffective or totally inoperable. Snow, having a large unit size, also tends to disrupt microwave beams in a profound way. Although nothing will fully penetrate the heaviest of rain and snow, a beam of mid-IR energy tends to have the greatest chance to get through.

Particulate associated with roadways also tends to be of a size which interferes with optical beams and cause them to be attenuated. This may include dust which is finely ground to particles of about one micron in diameter. Further, asbestos and other materials from which brake pads are made tends to leave those break pads and join the roadway environment. Rubber from tires and steel from mechanical systems all tend to result in a high concentration of dust of this nature on a common roadway. With heavy traffic, this matter is dispersed into the air surrounding a car which is the transmission medium of an anti-collision system. It is therefore desirable that a beam be resilient against being attenuated by this matter.

Therefore, where two cars are separated by optical path 10, a path which may contain pollutants and other matter which interferes with the transmission of electromagnetic radiation 11, it is a great advantage to arrange a probe beam in a form which is not subject strong attenuation. Accordingly, an anti-collision system based upon a Mid-IR optical beam is preferred. Although such mid-IR beams can be produced by gas lasers, such as a CO2 laser, it is a preferred embodiment that they be comprised of semiconductor lasers. Semiconductor lasers have great size, weight, lifetime, and expense advantages over gas type lasers.

These examples presented are directed to specific embodiments which illustrate preferred versions of devices and methods of these inventions. In the interests of completeness, a more general description of particular devices and the elements of which they are comprised as well as methods and the steps of which they are comprised is presented here following.

In some preferred embodiments, an optical illumination apparatus includes a mid-IR laser having an optical gain media which is pumped by electrical pulses. In addition, such a system might include a modulator in electrical communication with said laser. The modulator can be configured to drive periodic repetitive electrical pulses through the laser gain media. In this way, one best serves the objectives of an automobile collision avoidance system. This type of probe beam, i.e. a modulated beam having a predetermined modulation pattern, is useful for determining range of objects nearby in a spatial region of interest or field-of-regard. Reflections from nearby objects form a return signal which can be processed for information relating to distance of the object from the source.

Thus, an optical source for an anti-collision system includes a modulation scheme which results in a laser output of periodic repetitive nature, in a pattern to support a serial probing operation. That is to say, a series of pulses having a predetermined structure operates to form a range probe.

It is not only range that is of great interest in an automotive collision avoidance system, but rather directional information as well. Although systems having a great plurality of lasers each directed to a different region of space are fully contemplated, preferred versions include optical sources which may be scanned over various portions of a spatial region of interest. It is herein called a field-of-regard that defines the environment about a vehicle which relates to anti-collision issues.

An optical illumination apparatus therefore includes a laser which can be spatially redirected in a periodic repetitive nature to support a scanning operation over a spatial region. This may be achieved via a simple mirror mechanically driven by electrical impulses to cause the laser to point in various directions. Generally, a scan pattern is preset whereby the probe beam is directed serially over a large field-of-regard; any single pulse or preset group of pulses being directed into one region of space before the direction is changed and a similar set of pulses are directed into an adjacent region of space. Accordingly, these inventions also include those Mid-IR optical sources which can be both spatially and temporally modulated via electrical pulses repetitive in nature. Optical sources of these invention therefore include those having an output beam with a symmetry axis, the symmetry axis being aligned and directionally coupled to portions of a field-of-regard in a serial fashion.

It is not essential that a first region of space be illuminated just before or after an adjacent region of space. Indeed, some systems will track several cars or other objects at a single instant in time. In that case, the system may be placed into a state whereby regions known to contain objects are addressed preferentially with regard to those regions known to be clear. A laser may be alternately directed between to regions of space removed from each other, each containing a car therein. Thus, anticollision systems containing these optical sources have the symmetry axis of the output beam aligned coupled to portions of a field-of-regard in a random access fashion.

These inventions include processes as well as apparatus. In agreement, processes for optically illuminating a spatial region including the following three steps of: receiving an electronic signal having a repetitive temporal pattern; modulating a mid-IR laser by direct current injection with a waveform which corresponds to said repetitive temporal pattern; and coupling a resulting laser output beam into a field-of-regard. A computer may be arranged to produce a pattern corresponding to a range probe and/or spatial scan and present that pattern as an electrical signal to a modulator where it is received from the computer. On receipt, the modulator is charged with supplying sufficient current to the laser such that it activates and deactivates to produce a corresponding train of optical pulses matching the received signal. Thereafter, the output of the laser is directed into the field-of-regard. As mentioned, this modulation signal includes a predetermined pattern of pulses to serve as a range probe. As such, it may be described as a repetitive temporal pattern including a pattern suitable for determining range.

Processes further include systems having a plurality of lasers whereby each laser is driven at a different frequency or each laser produces a pulse set of different frequency. It is also possible to form a single quantum cascade laser which lases in two distinct frequencies. This rather remarkable property is not readily observed in the semiconductor cousins of the quantum cascade laser; i.e. in diode lasers.

In more detail, it can be said that these processes may include the steps of receiving a spatial pattern; and modulating a pointing apparatus in agreement with said spatial pattern whereby the output of the laser is coupled to various spatial regions in accordance with said spatial pattern. Accordingly, a transducer operates to convert the electrical pattern received into a pointing pattern. Experts in the field will recognize that crossed prisms, mirrors, among others are adequate beam steering elements for the purpose intended here.

One will now fully appreciate how light sources for anti-collision apparatus and anti-collision systems are arranged to improve reliability in inclement weather. Although the present invention has been described in considerable detail with clear and concise language and with reference to certain preferred versions thereof including the best mode anticipated by the inventor, other versions are possible. Therefore, the spirit and scope of the invention should not be limited by the description of the preferred versions contained therein, but rather by the claims appended hereto.

What is claimed is:

1) an optical illumination apparatus, comprising:
a mid-IR laser having an optical gain media; and
a modulator in electrical communication with said laser, the modulator configured to drive periodic repetitive electrical pulses through the laser gain media.

2) An optical illumination apparatus of claim 1, said periodic repetitive electrical pulses arranged in a pattern to support a serial probing operation.

3) An optical illumination apparatus of claim 1, said periodic repetitive electrical pulses arranged in a pattern to support a scanning operation over a spatial region.

4) An optical illumination apparatus of claim 3, said laser having an output beam with a symmetry axis, the symmetry axis being aligned and directionally coupled to portions of a field-of-regard in a serial fashion.

5) An optical illumination apparatus of claim 4, said laser having an output beam with a symmetry axis, the symmetry axis being aligned and directionally coupled to portions of a field-of-regard in a random access fashion.

6) A process for optically illuminating a spatial region, comprising:
receiving an electronic signal having a repetitive temporal pattern;
modulating a mid-IR laser by direct current injection with a waveform which corresponds to said repetitive temporal pattern; and
coupling a resulting laser output beam into a field-of-regard.

7) A process for optically illuminating a spatial region of claim 6, said receiving an electronic signal having a repetitive temporal pattern further includes a pattern suitable for determining range such as a group or groups of pulses.

8) A process for optically illuminating a spatial region of claim 6, further comprising modulation a plurality of lasers, each having a different frequency.

9) A process for optically illuminating a spatial region of claim 6, further comprising modulation a single QC laser which lases at two or more frequencies.

10) A process for optically illuminating a spatial region of claim 6, said process further comprises:
receiving a spatial pattern;
modulating a pointing apparatus in agreement with said spatial pattern whereby the output of the laser is coupled to various spatial regions in accordance with said spatial pattern.

11) Collision avoidance apparatus comprising a middle infra-red solid state laser.

12) Collision avoidance apparatus of claim 11, ‘middle infra-red’ being further characterized as wavelengths between 3.5 and 30 micrometers.

13) Collision avoidance apparatus of claim 11, said solid state laser being characterized as a quantum cascade type semiconductor laser.

14) Collision avoidance apparatus of claim 13, said quantum cascade laser being configured for continuous operation at room temperature.

15) Collision avoidance apparatus of claim 14, further comprising a thermal electric cooler thermally coupled to said quantum cascade laser.

16) Collision avoidance apparatus of claim 14, further comprising a high temperature InP regrowth layer about a quauntum cascade laser.

17) Collision avoidance apparatus of claim 11, said laser having an optical gain media; the apparatus further comprising a modulator in electrical communication with said laser, the modulator configured to drive periodic repetitive electrical pulses through the laser gain media.

18) Collision avoidance apparatus of claim 17, said periodic repetitive electrical pulses arranged in a pattern to support a serial probing operation.

19) Collision avoidance apparatus of claim 17, said periodic repetitive electrical pulses arranged in a pattern to support a scanning operation over a spatial region.

20) Collision avoidance apparatus of claim 17, said laser having an output beam with a symmetry axis, the symmetry axis being aligned and directionally coupled to portions of a field-of-regard in a serial fashion.

21) Collision avoidance apparatus of claim 17, said laser having an output beam with a symmetry axis, the symmetry axis being aligned and directionally coupled to portions of a field-of-regard in a random access fashion.

22) Methods of preventing automotive collisions comprising steps including: transmitting an optical beam of mid-IR energy produced at a solid state laser away from its source into a field-of-regard.

23) Methods of preventing automotive collisions of claim 22, said transmitting step is further characterized as producing a modulated optical beam by directly modulating laser drive current.

24) Methods of preventing automotive collisions of claim 23, further comprising the steps:
receiving return signals reflected from objects in the field-of-regard;
processing received return signals to determine spatial relationships of nearby objects; and
applying collision avoidance strategies based on processed signals.

25) Methods of preventing automotive collisions of claim 24, said receiving return signals step further includes detecting optical signals comprised of radiation between 3 and 20 microns at a high speed detector.

26) Methods of preventing automotive collisions of claim 23, said transmitting step is further comprised of transmitting an optical beam from a quantum cascade solid state laser modulated by direct current modulation.

27) Collision avoidance apparatus of claim 11, further comprising at least one high speed detector sensitive to optical radiation having a wavelength between 3 and 30 microns.

28) Collision avoidance apparatus of claim 27, said at least one detector having a detectivity characterized as D* is at least 1×10⁹, at temperatures greater than −70C.

29) Collision avoidance apparatus of claim 28, said at least one detector being a mercurycadmium-zinc-telluride, HgCdZnTe, detector.

30) Collision avoidance apparatus of claim 29, said at least one detector further comprising an integral immersion lens.

31) Collision avoidance apparatus of claim 27, said detector is a quantum well infrared photodetector.

32) Collision avoidance apparatus of claim 11, further comprising:
a programmed computer processing unit operable for signal processing, analysis, and decision making as it relates to collision avoidance;
optical source operable for producing a beam of optical energy of between 3 and 30 microns, arranged at the front of an automobile in a forward looking manner whereby a beam is emitted in a forward looking direction; and
a detector suitable in speed for a collision avoidance task.

33) Automotive collision avoidance apparatus of claim 11, further comprising: modulator characterized as a fast current source, said apparatus further including a beam steering mechanism compatible with mid-IR wavelength optical beams.
